(19) United States
(12) Patent Application Publication
(10) Pub. No.: US 2023/0115495 A1
(43) Pub. Date: Apr. 13, 2023

(54) IMPEDANCE MATCHING METHOD AND NETWORK DEVICE

(71) Applicant: REALTEK SEMICONDUCTOR CORPORATION, HSINCHU (TW)

(72) Inventor: CHIEN-SHENG LEE, HSINCHU (TW)

(21) Appl. No.: 17/861,362

(22) Filed: Jul. 11, 2022

(30) Foreign Application Priority Data
Sep. 10, 2021 (TW) 110133836

(51) Int. Cl. G06F 30/36

(52) U.S. Cl. CPC G06F 30/36; G06F 2115/12

(57) ABSTRACT

An impedance matching method includes following operations: providing load impedance data of a network interface controller chip; providing characteristic data of a network transformer, in which the network transformer is configured to be connected to the network interface controller chip via a transmission line on a printed circuit board, and a first predetermined data rate of the network transformer is lower than a second predetermined data rate of the network interface controller chip; adjusting an arrangement among the load impedance data, a length of the transmission line, and a width of the transmission line according to the characteristic data to adjust an impedance matching between the network transformer and the network interface controller chip, in order to make the network transformer meet a predetermined requirement corresponding to the second predetermined data rate; and storing the arrangement to be design data for fabricating the printed circuit board.

### BACKGROUND OF THE INVENTION

### 1. Field of the Invention

The present disclosure relates to a network device, especially to a network device that utilizes a network transformer having a lower specification to support high-speed Ethernet and an impedance matching method thereof.

### 2. Description of Related Art

With increasing Ethernet speed, hardware components used in network devices need to meet higher requirements of the communication specification. In order to meet the requirements of high-speed network applications, existing network devices will generally employ hardware components having the corresponding high specification directly to support high speed network. For example, in order to support 2.5G (i.e., 2.5 Gbps) Ethernet, network transformers in existing network device have a default (or native) specification that supports at least 2.5G Ethernet data rate and bandwidth. However, if the hardware components having higher specification are directly employed, the cost of production materials for network devices will be significantly increased.

### SUMMARY OF THE INVENTION

In some aspects of the present disclosure, an impedance matching method includes following operations: providing load impedance data of a network interface controller chip; providing characteristic data of a network transformer, in which the network transformer is configured to be connected to the network interface controller chip via a transmission line on a printed circuit board, and a first predetermined data rate of the network transformer is lower than a second predetermined data rate of the network interface controller chip; adjusting an arrangement among the load impedance data, a length of the transmission line, and a width of the transmission line according to the characteristic data to adjust an impedance matching between the network transformer and the network interface controller chip, in order to make the network transformer meet a predetermined requirement corresponding to the second predetermined data rate; and storing the arrangement to be design data for fabricating the printed circuit board.

In some aspects of the present disclosure, a network device includes a network interface controller chip having load impedance data, a transmission line formed on a printed circuit board, and a network transformer connected to the network interface controller chip via the transmission line. The network transformer does not support a first predetermined data rate of the network interface controller chip, and the load impedance data, a length of the transmission line, and a width of the transmission line are arranged to adjust an impedance matching between the network transformer and the network interface controller chip, in order to make the network transformer meet a predetermined requirement corresponding to the first predetermined data rate.

These and other objectives of the present disclosure will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows a schematic diagram of a network device according to some embodiments of the present disclosure.

FIG. 2 shows a circuit model corresponding to the network device in FIG. 1 according to some embodiments of the present disclosure.

FIG. 3 shows a schematic diagram of the transmission lines in FIG. 1 according to some embodiments of the present disclosure.

FIG. 4 shows a flow chart of an impedance matching method according to some embodiments of the present disclosure.

FIG. 5A shows a schematic diagram of a simulation result and a measurement result of a return loss according to some embodiments of the present disclosure.

FIG. 5B shows a schematic diagram of a simulation result of return loss according to some embodiments of the present disclosure.

FIG. 6 shows a schematic diagram of a circuit simulation system according to some embodiments of the present disclosure.

FIG. 7 shows a flow chart of operations of the controller circuit in FIG. 1 according to some embodiments of the present disclosure.

### DETAILED DESCRIPTION OF THE PREFERRED EMBODIMENTS

The terms used in this specification generally have their ordinary meanings in the art and in the specific context where each term is used. The use of examples in this specification, including examples of any terms discussed herein, is illustrative only, and in no way limits the scope and meaning of the disclosure or of any exemplified term. Likewise, the present disclosure is not limited to various embodiments given in this specification.

In this document, the term “coupled” may also be termed as “electrically coupled,” and the term “connected” may be termed as “electrically connected.” “Coupled” and “connected” may mean “directly coupled” and “directly connected” respectively, or “indirectly coupled” and “indirectly connected” respectively. “Coupled” and “connected” may also be used to indicate that two or more elements cooperate or interact with each other. In this document, the term “circuit” may indicate an object, which is formed with one or more transistors and/or one or more active/passive elements based on a specific arrangement, for processing signals.

As used herein, the term “and/or” includes any and all combinations of one or more of the associated listed items. Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments. For ease of understanding, like elements in various figures are designated with the same reference number.

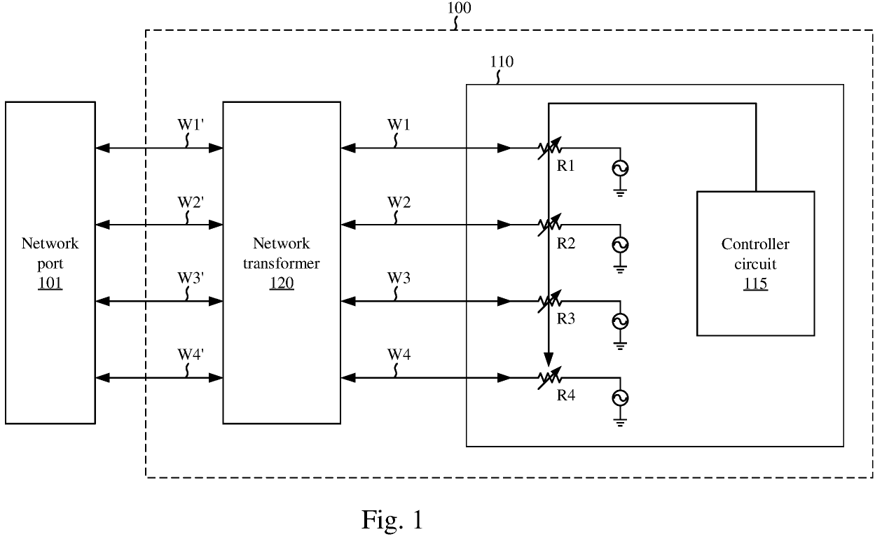

FIG. 1 shows a schematic diagram of a network device 100 according to some embodiments of the present disclosure. The network device 100 includes a network interface controller chip 110, the transmission lines W1-W4, the transmission lines W1ʹ-W4ʹ, and a network transformer (or referred to as LAN transformer) 120.

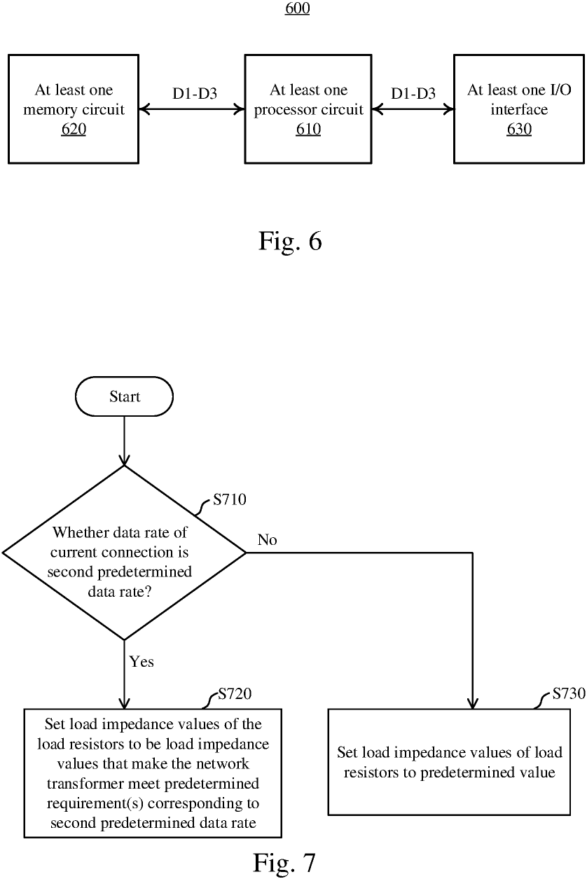

The network interface controller chip 110 is connected to the network transformer 120 via the transmission lines W1-W4. In some embodiments, the network interface controller chip 110 may support 2.5G Ethernet. The network interface controller chip 110 may provide various functions (which may include, but not limited to, crossing detection, equalization, crosstalk cancellation, echo cancellation, timing recovery, error calibration, and so on), in order to improve the quality of data transmission. In some embodiments, the network interface controller chip 110 includes load resistor R1-R4 and a controller circuit 115. The load resistor R1-R4 are coupled to connection ports of the network transformer 120 respectively via the transmission lines W1-W4. Each of the load resistor R1-R4 is an adjustable termination resistor. As mentioned in FIG. 7, the controller circuit 115 may adjust the load impedance value of the load resistor R1-R4 according to the actual data rate of the network, in order to adjust the impedance matching between the network interface controller chip 110 and the network transformer 120 to maintain a certain transmission quality.

The network transformer 120 is coupled to a network port 101 via the transmission lines W1ʹ-W4ʹ, in order to be connected to Internet. In some embodiments, the network port 101 may be a RJ-45 connector, which may be configured to be connected with Ethernet. In some embodiments, the transmission lines W1-W4 and the transmission lines W1'-W4' may be signal paths formed on a printed circuit board. In some embodiments, each of the transmission lines W1-W4 and the transmission lines W1ʹ-W4ʹ includes a pair of differential lines in a medium dependent interface.

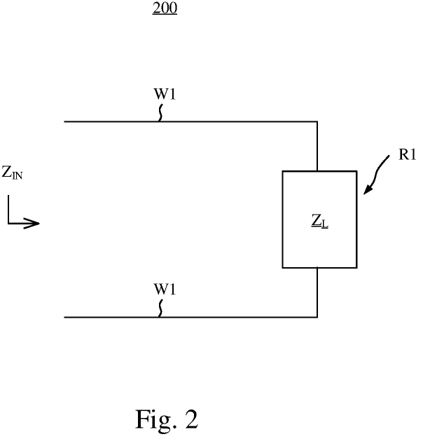

A default data rate supported by the network transformer 120 (hereinafter referred to as “first predetermined data rate”) is lower than a default data rate supported by the network interface controller chip 110 (hereinafter referred to as “second predetermined data rate”). That is, the network transformer 120 does not support the second predetermined data rate of the network interface controller chip 110 natively. For example, the first predetermined data rate of the network transformer 120 is a date rate of 1G Ethernet (i.e., 1 gigabit per second (Gbps)), and the second predetermined data rate of the network interface controller chip 110 is a data rate of 2.5G Ethernet (i.e., 2.5 Gbps). By adjusting the load impedance values of the load resistor R1-R4, lengths and widths of the transmission lines W1-W4, and those of the transmission lines W1ʹ-W4ʹ, the impedance matching between the network transformer 120 and the network interface controller chip 110 can be adjusted. As a result, the network transformer 120 is adjusted to meet a predetermined requirement corresponding to the second predetermined data rate. In other words, with the above adjustments, it is able to utilize the network transformer 120 with lower specifications (e.g., the original specification is only for supporting 1G Ethernet) to support the network interface controller chip 110 having higher specification (e.g., the original specification is for supporting 2.5G Ethernet), such that the network device 100 is able to operate with the second predetermined data rate. As a result, the overall hardware cost of the network device 100 can be reduced. Descriptions regarding the above adjustments are given with reference to FIG. 2 to FIG. 4.

FIG. 2 shows a circuit model 200 corresponding to the network device 100 in FIG. 1 according to some embodiments of the present disclosure. For one connection port in the network transformer 120 (e.g., a connection port connected to the transmission line W1), a input impedance Z_{IN} of the network interface controller chip 110 includes an impedance of the transmission line W1 and a load impedance value Z_{L} of the load resistor R1, in which the impedance of the transmission line W1 is a characteristic impedance. Based on transmission line theory, it can be derived that the input impedance Z_{IN} is satisfied with the following equation (1):

$${Z}_{I N} = {Z}_{0} \frac{{Z}_{L} + j {Z}_{0} ( tan β L )}{{Z}_{0} + j {Z}_{L} ( tan β L )}$$

in which β is a wave number, L is the length of the transmission line W1, and Z₀ is the characteristic impedance of the transmission line W1. Based on the equation (1), in order to adjust the impedance matching between one connection port of the network transformer 120 and the network interface controller chip 110, at least one of the length L of the transmission line W1 (which may control phase), the width of the transmission line W1 (which may adjust the characteristic impedance Z₀), and/or the load impedance value Z_{L} of the network interface controller chip 110 can be adjusted.

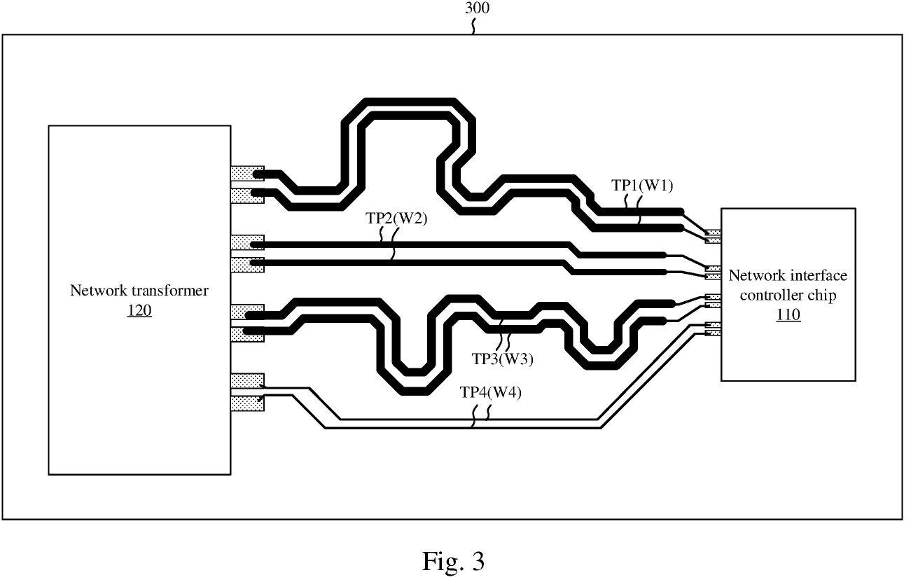

FIG. 3 shows a schematic diagram of the transmission lines W1-W4 in FIG. 1 according to some embodiments of the present disclosure. For ease of illustration, FIG. 3 only shows the arrangements among the network interface controller chip 110, the network transformer 120, and the transmission lines W1-W4 in FIG. 1. It should be understood that, in practical applications, a printed circuit board 300 in FIG. 3 (which may be, but not limited to, a circuit board), may further include more transmission lines (i.e., the transmission lines W1ʹ-W4ʹ in FIG. 1), in order to be connected to the network port 101 via the network transformer 120. In FIG. 3, an input/output pad of each of the network transformer 120 and the network interface controller chip 110 is shown with dots.

As mentioned above, in order to improve the input impedance Z_{IN}, the width (which may control the characteristic impedance Z₀) and the length (which may control phase) of the transmission line W1 can be adjusted. In some embodiments, the equivalent inductor (L) and the capacitor (C) of the transmission line W1 can be adjusted by adjusting the width and the length of the transmission line W1, in order to adjust the characteristic impedance Z₀ As shown in FIG. 3, differential line pairs TP1-TP4 correspond to the transmission lines W1-W4 in FIG. 1. In order to make the network transformer 120 meet a predetermined requirement corresponding to the second predetermined data rate, the required width or length for the differential line pairs TP1-TP4 may be different.

For example, as shown in FIG. 3, the width of each segment in the differential line pairs TP1-TP3 is wider than that of each segment in the differential line pair TP4. From the network transformer 120 to the network interface controller chip 110, the total length of segments in the differential line pair TP1 (which equals to the length L in the equation (1)) is longer than that of segments in the differential line pair TP2 or TP4. With such arrangements, the impedance (which equals to the characteristic impedance Z₀ in the equation (1)) of the differential line pair can be adjusted. For example, the width of the differential line pair TP4 is set to be a predetermined value (for example, 5 mil), and the differential impedance of the different line pair TP4 is set to be a predetermined value (e.g., 100 ohms). Correspondingly, the width of the differential line pair TP1 is set to be 23 mil, and the length of the differential line pair TP1 is set to be 3 cm, such that the differential impedance of the different line pair TP1 is 40 ohms.

In some embodiments, the layout diagram shown in FIG. 3 may be generated from software for designing printed circuit board. For example, such software may be Cadence allegro, PADS Layout, and so on. The arrangements of each segment and each length and the types of the software for designing printed circuit board are given for illustrative purposes, and the present disclosure is not limited thereto.

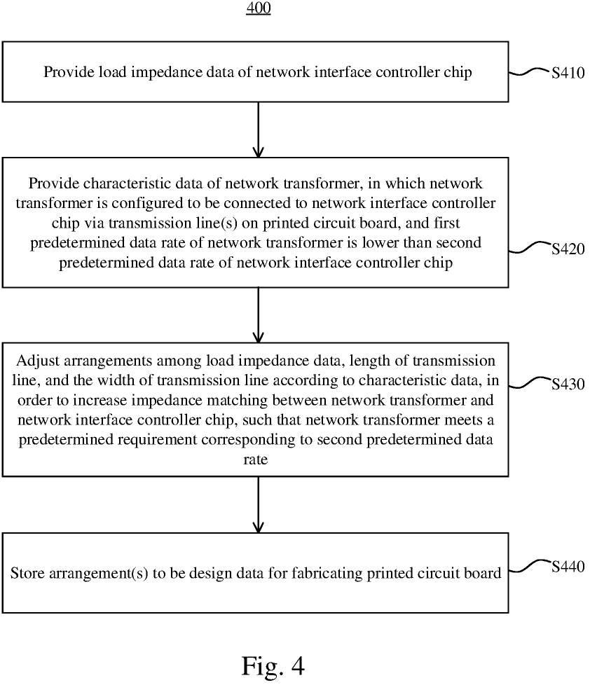

FIG. 4 shows a flow chart of an impedance matching method 400 according to some embodiments of the present disclosure. In some embodiments, the impedance matching method 400 is configured to automatically determine the layout design (i.e., routing, width, length, and so on) of the transmission lines W1-W4 in FIG. 1 (and/or transmission lines W1ʹ-W4ʹ).

In operation S410, load impedance data (e.g., S parameters) of a network interface controller chip is provided. As mentioned above, the network interface controller chip 110 has the load resistor R1-R4. In some embodiments, each of the load resistor R1-R4 may be a variable resistor, which can provide n load impedance values (e.g., Z[1]-Z[n], in which n is a positive integer higher than 1, and each of Z[1]-Z[n] may be expressed in a complex number such as Z=R+jX) in response to the control of the controller circuit 115. In some embodiments, a circuit simulation may be performed with a post simulation file of the network interface controller chip 110, or a measurement may be performed on the network interface controller chip 110, in order to acquire the load impedance values Z[1]-Z[n] and generate the load impedance data accordingly. In other words, the load impedance data include information of the load impedance values Z[1]-Z[n] provided by each of the load resistor R1-R4, and the network interface controller chip 110 may adjust the load resistor R1-R4 according to the load impedance data, in order to set the corresponding load impedance value.

With continued reference to FIG. 4, in operation S420, characteristic data of a network transformer is provided, in which the network transformer is configured to be connected to the network interface controller chip via transmission line(s) on a printed circuit board (as shown in FIG. 3), and a first predetermined data rate (e.g., 1 Gbps) of the network transformer is lower than a second predetermined data rate (e.g., 2.5 Gbps) of the network interface controller chip.

In some embodiments, with the circuit simulation analysis (e.g., S parameter cascade analysis) on the circuit model 200, it can be derived that when the network transformer 120 operates in a predetermined frequency (e.g., 125 megahertz (MHz)), the input impedance is an inductive input impedance (i.e., the imaginary part of the input impedance is positive), and the return loss is able to meet the predetermined requirement (as mentioned in operation S430). Therefore, by performing S parameter measurement and analysis on multiple network transformers, input impedances of those network transformers can be obtained, at least one having the inductive input impedance of the network transformers is selected to be the network transformer 120, and information about the input impedance (e.g., Zin[1]-Zin[y] in the table 1, in which in which y is a positive integer higher than or equal to 1) of the at least one of the network transformers (e.g., network transformers 120[1]-120[y] in the following table 1) can be stored as the characteristic data. For example, the characteristic data can be expressed as the following table 1:

TABLE 1

| | |
|---|---|
| network transformer 120[1] | input impedance Zin[1] |
| network transformer 120[2] | input impedance Zin[2] |
| . . . | . . . |
| network transformer 120[y] | input impedance Zin[y] |

The above content of the characteristic data is given for illustrative purposes, and the present disclosure is not limited thereto. In different embodiments, in order to perform operation S430, the characteristic data may include more component parameters about the network transformer 120 (e.g., inductance value, insertion loss, reflect loss, pin location, and so on).

With continued reference to FIG. 4, in operation S430, the arrangements among the load impedance data, the length of the transmission line, and the width of the transmission line are adjusted according to the characteristic data, in order to increase the impedance matching between the network transformer and the network interface controller chip, such that the network transformer conforms to a predetermined requirement corresponding to the second predetermined data rate.

For example, in order to make the network device 100 able to operate in the second predetermined data rate, the network transformer 120 which is connected to the network interface controller chip 110 via the transmission lines W1-W4 is required to be conformed with requirements of communication standard corresponding to the second predetermined data rat. For example, in order to conform to requirements of 2.5G Ethernet (e.g., IEEE 802.3 bz), the return loss of the network transformer 120 operating at a predetermined frequency (e.g., 125 MHz) is required to be less than -11.05 dB (which may be considered as the aforementioned predetermined requirement). With circuit simulations, it is able to adjust the arrangement among the load impedance data, the length of the transmission lines, and the width of the transmission lines, and measure the return loss of the network transformer 120 and the network interface controller chip 110 at 125 MHz under the adjusted arrangement. If the return loss is less than -11.05 dB, the arrangement is recorded.

In greater detail, for one network transformer (e.g., network transformer 120[1]) and one of the load impedance value Z[1]-Z[n] (e.g., load impedance value Z[1]) in the table 1, the length and/or the width of one of the transmission lines W1-W4 (e.g., transmission line W1) can be adjusted within a predetermined area (i.e., a certain region on the printed circuit board) by routing and circuit simulation software, such that the return loss of the network transformer 120[1] cooperating with the network interface controller chip 110 and operating at the frequency of 125 MHz is less than -11.05 dB. If there is the width and/or the length that are satisfied with the above condition, the circuit simulation software will store such width and/or length to be an arrangement corresponding to the network transformer 120[1] and the load impedance value Z[1]. Afterwards, the circuit simulation software may switch to the load impedance value Z[2], and perform the similar operations to find the length and/or the width of the transmission line that able to make the return loss of the network transformer 120[1] meet the predetermined requirement. By repeatedly performing the above operations, it is able to find an optimized arrangement with the circuit simulation software, and the optimized arrangement is the corresponding relationship between lengths (and widths) of transmission lines and load impedance values that may make the network transformers 120[1]-120[n] meet the predetermined requirements.

In operation S440, the arrangement is stored to be design data for fabricating the printed circuit board. For example, after one or more arrangements among the length, the width, and the load impedance values that are able to make the network transformers 120[1]-120[y] in the table 1 meet the predetermined requirements are found, these arrangements may be stored as a layout design rule (i.e., design data), and the layout design rule may be provided to a manufacturer of network products. The manufacturer may select one of the network transformers 120[1]-120[y] to be the network transformer 120 according to that layout design rule, and implement the length and the width of transmission lines on the printed circuit board (as shown in FIG. 3) according to the suggested arrangements in the layout design rule. With the printed circuit board fabricated based on the above arrangement, it is able to make the network transformer 120 having lower specification be able to support the network interface controller chip 110 having higher specification. Under this condition, the network device 100 is able to achieve higher data rate without employing the network transformer having higher specification. As a result, the hardware cost of the network device 100 can be reduced.

The above description of the impedance matching method 400 includes exemplary operations, but the operations of the impedance matching method 400 are not necessarily performed in the order described above. Operations of the impedance matching method 400 can be added, replaced, changed order, and/or eliminated, or the operations of the impedance matching method 400 can be executed simultaneously or partially simultaneously as appropriate, in accordance with the spirit and scope of various embodiments of the present disclosure.

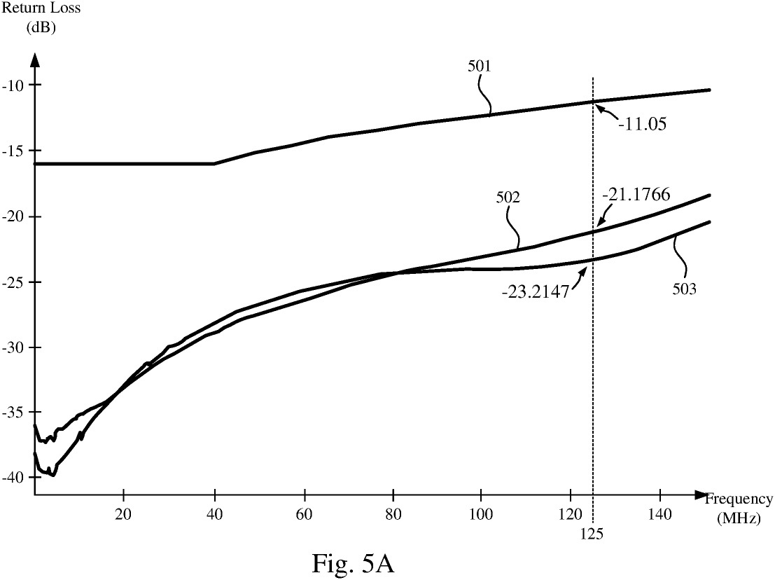

FIG. 5A shows a schematic diagram of a simulation result and a measurement result of a return loss according to some embodiments of the present disclosure. In an experimental example, a curve 501 indicates predetermined requirement(s) of 2.5G Ethernet. When operating in a frequency of 125 MHz, the return loss of the network transformer 120 with the network interface controller chip 110 is required to be lower than -11.05 dB. A curve 502 corresponds to an analysis result from circuit simulation, which indicates that the return loss (e.g., -21.1766 dB) of the network transformer 120 under an arrangement of a group of length and width of transmission lines found in operation S430. A curve 503 corresponds to a practical measurement result, which indicates that the return loss (e.g., -23.2147 dB) of the network transformer 120 with the network interface controller chip 110 and a printed circuit board fabricated based on the design data. As a result, it can be known that with such arrangement, the network transformer 120 having lower specification is able to support the second predetermined data rate that corresponds to higher specification.

FIG. 5B shows a schematic diagram of a simulation result of return loss according to some embodiments of the present disclosure. Examples in FIG. 5A and FIG. 5B employ different network transformer 120. Same as FIG. 5A, the curve 501 indicates the predetermined requirements of 2.5G Ethernet. In this experiential example, a curve 504 indicates a simulation result before the width and the length of transmission lines are adjusted, and a curve 505 indicates a simulation result after the width and the length of transmission lines are adjusted. Before adjusting the width and the length of the transmission lines, the impedance of the transmission line is set to be 100 ohms, and its original load impedance value is set to be (93.8-j15) ohms. After adjusting the width and the length of the transmission lines, the impedance of the transmission line is set to be 50 ohms. In response to the adjusted impedance, the load impedance value is adjusted to be (99-j19) ohms to improve impedance matching between the network transformer 120 and the network interface controller chip 110. As shown in FIG. 5B, according to the curve 504, the return loss of the network transformer 120 on the printed circuit board before being adjusted with the network interface controller chip 110 is -11.34 dB. According to the curve 505, the return loss of the network transformer 120 on the adjusted printed circuit board with the network interface controller chip 110 is -13.992 dB. Therefore, it can be known that, with the adjustment in some embodiments of the present disclosure, the return loss can be improved by at least 2 dB. The values given FIG. 5A and FIG. 5B are given for illustrative purposes, and the present disclosure is not limited thereto.

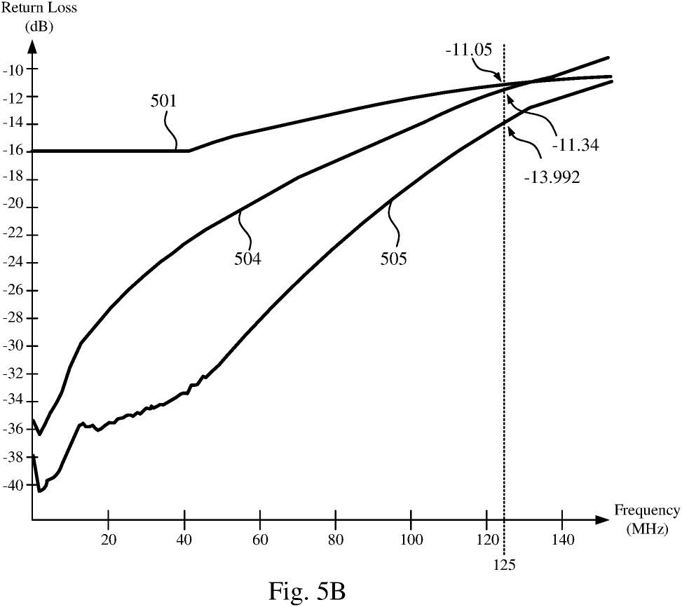

FIG. 6 shows a schematic diagram of a circuit simulation system 600 according to some embodiments of the present disclosure. The circuit simulation system 600 may perform the impedance matching method 400 in FIG. 4, in order to generate the design data automatically.

The circuit simulation system 600 includes at least one processor circuit 610, at least one memory circuit 620, and at least one Input/output (I/O) interface 630. The at least one processor circuit 610 is coupled to the at least one memory circuit 620 and the at least one I/O interface 630. In different embodiments, the at least one processor circuit 610 may be, but not limited to, a central processing unit (CPU), an application-specific integrated circuit, or a distributed processing system, and so on. Various circuits or units to implement the at least one processor circuit 610 are within the contemplated scope of the present disclosure.

The at least one memory circuit 620 stores at least one program code which is for aiding the design of length and impedance wires on a printed circuit board. For example, the at least one program code is encoded with multiple instruction sets which are configured to execute a network analysis to verify return loss. In some embodiments, the at least one processor circuit 610 may perform program codes stored in the at least one memory circuit 620, in order to perform operations in FIG. 4. In some embodiments, the at least one memory circuit 620 may store the load impedance data (labeled as D1) and the characteristic data (labeled as D2), in order to provide those data to the at least one processor circuit 610 for performing various circuit simulations and network analysis. In some embodiments, the at least one memory circuit 620 may store the simulation results (e.g., arrangements among impedance values, widths, and lengths that are able to meet predetermined requirements) of the above circuit simulations, and output those results to be the design data (labeled as D3). In some embodiments, the at least one memory circuit 620 further stores at least one computer-aided design software, which is configured to extract information about length and/or width of various transmission lines from layout diagram data of printed circuit board. For example, the at least one computer-aided software may be, but not limited to, software for designing printed circuit board.

In some embodiments, the at least one memory circuit 620 may be a non-transitory computer readable storage medium, which stores at least one program code for running circuit simulation(s). For example, the at least one memory circuit 620 stores executable instructions for performing the impedance matching method 400. In some embodiments, the computer readable medium may be, but not limited to, electronic, magnetic, optical, infrared, and/or semiconductor device(s). For example, the computer readable storage medium includes, but not limited to, semiconductor or solid-state memory, tape, removable computer disk, RAM, ROM, rigid disk and/or optical disk. In some embodiments, the optical disk includes, but not limited to, CD-ROM, CD-R/W, and/or DVD.

The at least one I/O interface 630 may receive data (e.g., the load impedance data D1 and the characteristic data D2) and/or commands from various control devices which are manipulated by a circuit designer or a printed circuit board designer. Accordingly, the circuit simulation system 600 may be manipulated by inputs or commands from the at least one I/O interface 630. In some embodiments, the at least one I/O interface 630 includes a screen that shows a status of execution of the program code and/or a simulation result of return loss. In some embodiments, the at least one I/O interface 630 may include, but not limited to, a graphic user interface (GUI). In some embodiments, the at least one I/O interface 630 may include a keyboard, keypad, mouse, trackball, trackpad, touch screen, and/or cursor direction keys.

In some embodiments, the functions of the circuit simulation system 600 may be integrated with an existing computer-aided design software, or may cooperate with the computer-aided design software to perform the impedance matching method 400 to generate the design data D3.

FIG. 7 shows a flow chart of operations of the controller circuit 115 in FIG. 1 according to some embodiments of the present disclosure. In some embodiments, operations in FIG. 7 may be executed by firmware or software of the controller circuit 115, in order to adjust the load resistor R1-R4.

In operation S710, whether a data rate of current connection is the second predetermined data rate (e.g., 2.5 Gbps) is determined. If the data rate of current connection is the second predetermined data rate, operation S720 is performed. If the data rate of current connection is not the second predetermined data rate, operation S730 is performed.

In operation S720, the load impedance values of the load resistors are set to be load impedance values that make the network transformer meet predetermined requirement(s) corresponding to the second predetermined data rate. For example, the design data D3 may be transmitted to the controller circuit 115 via a firmware updating process. If the controller circuit 115 detects that the current connection is 2.5G Ethernet, the controller circuit 115 is able to set the load impedance values of the resistors R1-R4 according to the design data D3, in order to assure that the return loss of the network transformer 120 meets requirements of 2.5G Ethernet standard.

In operation S730, the load impedance values of the load resistors are set to predetermined values. For example, if the controller circuit 115 detects that the current connection is a 1G Ethernet, the controller circuit 115 may set the load impedance values of the resistors R1-R4 to be the predetermined value.

As described above, the impedance matching method and the network device in some embodiments of the present disclosure may adjust width and length of transmission lines on a printed circuit board to make a network transformer having lower specification support higher data rate. As a result, it is able to reduce overall cost while maintaining the transfer rate.

Various functional components or blocks have been described herein. As will be appreciated by persons skilled in the art, in some embodiments, the functional blocks will preferably be implemented through circuits (either dedicated circuits, or general purpose circuits, which operate under the control of one or more processors and coded instructions), which will typically comprise transistors or other circuit elements that are configured in such a way as to control the operation of the circuitry in accordance with the functions and operations described herein. As will be further appreciated, the specific structure or interconnections of the circuit elements will typically be determined by a compiler, such as a register transfer language (RTL) compiler. RTL compilers operate upon scripts that closely resemble assembly language code, to compile the script into a form that is used for the layout or fabrication of the ultimate circuitry. Indeed, RTL is well known for its role and use in the facilitation of the design process of electronic and digital systems.

The aforementioned descriptions represent merely the preferred embodiments of the present disclosure, without any intention to limit the scope of the present disclosure thereto. Various equivalent changes, alterations, or modifications based on the claims of the present disclosure are all consequently viewed as being embraced by the scope of the present disclosure.

What is claimed is:

1. An impedance matching method, comprising:
providing load impedance data of a network interface controller chip;
providing characteristic data of a network transformer, wherein the network transformer is configured to be connected to the network interface controller chip via a transmission line on a printed circuit board, and a first predetermined data rate of the network transformer is lower than a second predetermined data rate of the network interface controller chip;
adjusting an arrangement among the load impedance data, a length of the transmission line, and a width of the transmission line according to the characteristic data to adjust an impedance matching between the network transformer and the network interface controller chip, in order to make the network transformer meet a predetermined requirement corresponding to the second predetermined data rate; and
storing the arrangement to be design data for fabricating the printed circuit board.

2. The impedance matching method of claim 1, wherein the load impedance data comprises information of a plurality of load impedance values, and the network controller chip comprises a variable resistor that is configured to provide one of the plurality of load impedance values.

3. The impedance matching method of claim 1, wherein adjusting the arrangement among the load impedance data, the length of the transmission line, and the width of the transmission line according to the characteristic data to adjust the impedance matching between the network transformer and the network interface controller chip, in order to make the network transformer meet the predetermined requirement corresponding to the second predetermined data rate comprises:
adjusting a load impedance value in the load impedance data, the length of the transmission line, and the width of the transmission line based on a circuit simulation, in order to determine whether a return loss of the network transformer that is connected to the network interface controller chip via the transmission line meets the predetermined requirement; and
if the return loss meets the predetermined requirement, storing the arrangement among the adjusted load impedance value, the adjusted length, and the adjusted width.

4. The impedance matching method of claim 1, wherein the characteristic data comprises information about an input impedance of the network transformer operating at a predetermined frequency, and the predetermined frequency corresponds to the second predetermined data rate.

5. The impedance matching method of claim 4, wherein the input impedance is an inductive input impedance.

6. The impedance matching method of claim 4, wherein the predetermined frequency is 125 megahertz.

7. The impedance matching method of claim 1, wherein the first predetermined data rate is 1 gigabit per second, and the second predetermined data rate is 2.5 gigabit per second.

8. A network device, comprising:
a network interface controller chip having load impedance data;
a transmission line formed on a printed circuit board; and
a network transformer connected to the network interface controller chip via the transmission line,
wherein the network transformer does not support a first predetermined data rate of the network interface controller chip, and the load impedance data, a length of the transmission line, and a width of the transmission line are arranged to adjust an impedance matching between the network transformer and the network interface controller chip, in order to make the network transformer meet a predetermined requirement corresponding to the first predetermined data rate.

9. The network device of claim 8, wherein the network transformer natively supports a second predetermined data rate, and the second predetermined data rate is lower than the first predetermined data rate.

10. The network device of claim 9, wherein the second predetermined data rate is 1 gigabit per second, and the first predetermined data rate is 2.5 gigabit per second.

11. The network device of claim 8, where the load impedance data comprises information about a plurality of load impedance values, the network interface controller chip comprises a variable resistor, and the variable resistor is configured to provide one of the plurality of the load impedance values.

12. The network device of claim 11, wherein if the network interface controller chip detects that the network transformer operates at the first predetermined data rate, the network interface controller chip is further configured to adjust the variable resistor, in order to make the network transformer meet the predetermined requirement.

13. The network device of claim 9, wherein an input impedance of the network transformer operating at a predetermined frequency is an inductive input impedance, and the predetermined frequency corresponds to the first predetermined data rate.

14. The network device of claim 13, wherein the predetermined frequency is 125 megahertz.
